(19) United States
(12) Patent Application Publication
(10) Pub. No.: US 2017/0109473 A1
(43) Pub. Date: Apr. 20, 2017

(54) Method and system for detecting and identifying patients who did not obtain the relevant recommended diagnostic test or therapeutic intervention, based on processing information that is present within radiology reports or other electronic health records

(71) Applicant: Michal Kulon, East Setauket, NY (US)

(72) Inventor: Michal Kulon, East Setauket, NY (US)

(21) Appl. No.: 14/887,331

(22) Filed: Oct. 20, 2015

(51) Int. Cl. G06F 19/00

(52) U.S. Cl. CPC G06F 19/322

(57) ABSTRACT

Occasionally relevant findings and important recommendations made within medical or radiology reports fail to elicit the appropriate follow-up due to multiple factors. The clinician may miss the recommendation or lose track of it while addressing a more acute illness, the recommendation may have not been conveyed to the patient, or the patient may fail to schedule or show-up for the subsequent exam. Prior literature indicates that a significant percentage of scheduled appointments result in no-shows or cancellations by patients, and a small but significant percentage of indicated follow-up studies are thus not obtained. Such omissions occasionally result in adverse consequences suffered by the patients, and increase the risk of legal liabilities to the clinicians or radiologists. A method and system is presented that identifies patients who did not obtain such recommended diagnostic tests or therapeutic interventions, and which sorts and filters the detected patients according to relevance of the recommendation, optionally discarding recommendations of low relevance, and facilitates the management of the detected patients.

### FIELD OF THE INVENTION

The invention relates generally to the health-care industry, processing of electronic text, more particularly to natural language processing in the areas of radiology and general health-care, detecting and assessing the relevance of the recommendations, and managing of the resulting information. Group of persons or a single person skilled in the arts of Natural Language Processing, Computer Programming, Regular Expressions, Medical and Radiologic Terminology will be able to implement the invention based on the description contained herein.

### BACKGROUND OF THE INVENTION

Radiology and other medical reports sometimes recommend additional tests or interventions. Automated detection of keywords or phrases within reports such as “CT is recommended”, “Bone Scan is advised,” “consider MRI” can help to identify reports that may be of interest in the overall process of ensuring that follow-ups are obtained, but this generally results in the undesired inclusion of patients who have already obtained the indicated tests, and also concomitant detection of recommendations that are of low relevance, such as recommendations that are made on nearly every scan performed for a particular purpose, common examples being CT Head performed for suspicion of stroke wherein some radiologists routinely include a phrase “if there is a clinical suspicion for stroke, MRI is recommended”, and wrist x-rays obtained for trauma routinely stating phrases such as “if pain persists, recommend repeat radiographs in 7-14 days.” Finally, a particular healthcare institution may not be interested in enforcing follow-up on a subset of recommendations.

Health records at many institutions are presently commonly stored and processed by multiple sub-systems often provided by different vendors. These sub-systems are presently integrated together to varying extents at different institutions. For example, there may be separate systems for generation or radiology reports, separate electronic chart system, and a separate scheduling system. In current practice, information from some of such sub-systems may not be available to the present invention, in which case the invention should still perform its functions as well as possible, based on incomplete information. A common example of this may be that radiology reports are available to the invention, but the data pertaining to patient's scheduled future exams may be not available.

### DESCRIPTION OF PRIOR ART

US Patent Application 20140288970: Identifying Relevant Imaging Examination

Recommendations For A Patient From Prior Medical Reports Of The Patient To Facilitate Determining A Follow Up Imaging Examination(S) For The Patient.
US Patent Application W0/2015/136404: System And Method For Scheduling Healthcare Follow-Up Appointments Based On Written Recommendation/

US Patent Application 20140288970 describes the use of related natural-language processing techniques related to radiology, detection of recommendations, similar concept of highlighting of pertinent phrases, and a concept of relevance scoring the detected recommendations according to a metric of relevance that appears to largely represent a likelyhood that a particular sentence makes a recommendation, with relevance related to the exam which is being contemplated or protocoled by a physician. However, the present invention comprises other and additional elements and improvements that were not encompassed by US Patent Application 20140288970. Furthermore, the current invention includes other elements which allow it to be applied for an entirely different purpose of detecting which of the prior patients did not obtain the recommended follow-ups. This is in contradistinction to US Patent Application 20140288970, which focuses on presenting prior pertinent information relating to which scan was previously recommended and what was the prior clinical hypothesis that elicited the new scan to be ordered, with apparent intent to assist a physician in the process of designing and optimizing a new exam for a particular patient for whom an imaging order has been already appropriately placed, and who typically would already be scheduled or who would have arrived for their appointment.

US Patent Application WO/2015/136404 describes a related function to the current invention, a related use of different natural-language processing techniques within the field of radiology to detect phrases that recommend follow-ups, and a means of checking if the detected recommendations were scheduled. Such checking for scheduled exams is suboptimal for several reasons. First, it is possible that an exam scheduled for the future may never be actually performed, which happens frequently in practice. Published literature in the fields of radiology and other medical specialties indicates that a significant percentage of patients cancel their appointments or fail to show up for scheduled appointments, occasionally resulting in adverse consequences, such as if a malignancy or other disease is not diagnosed, or diagnosed after a delay. US Patent Application WO/2015/136404 entirely omits any method of verifying that the recommended exam has been actually performed, and in passing mentions comparing a current date to the date associated with a scheduled exam as a crude and fallible means of estimation that the exam has been performed. The present invention comprises a means by which it can determine that a study has been completed rather than only scheduled. Sample literature relating to the tendency of patients to miss appointments includes:
1. Margolis K L, Menart T C. A test of two interventions to improve compliance with scheduled mammography appointments. J Gen Intern Med. 1996;11(9):539-41.
2. Reports with Incidental Pulmonary Nodules. Stud Health Technol Inform. 2015;216:1028.
3. Salaverria C, Rossell N, Hernandez A, et al. Interventions targeting absences increase adherence and reduce abandonment of childhood cancer treatment in El Salvador. Pediatr Blood Cancer. 2015;62(9):1609-15.
4. Sheppard V B, Huei-yu wang J, Eng-wong J, Martin S H, Hurtado-de-mendoza A, Luta G. Promoting mammography adherence in underserved women: the telephone coaching adherence study. Contemp Clin Trials.
5. 2013;35(1):35-42.
6. Weinmann S, Taplin S H, Gilbert J, et al. Characteristics of women refusing follow-up for tests or symptoms suggestive of breast cancer. J Natl Cancer Inst Monographs. 2005;(35):33-8.

Second, many of contemporary hospitals and imaging center tend to utilize a separate system for scheduling and a separate system for report generation. In many hospitals or imaging centers, the scheduling system may lack the ability to communicate its data to a device which functions to check if recommended follow-ups were obtained. In the cases where establishing such communication is possible, doing so may be expensive and difficult. Therefore, any embodiment of what is described in US Patent Application WO/2015/136404 may simply not be able to be installed or function in many contemporary hospitals or imaging centers. In contradistinction, the improvements and additional elements of the current invention enable its embodiments to be successfully deployed at majority of contemporary hospitals, and thus enable its important functions to be performed.

Third, US Patent Application WO/2015/136404 implies a direct automated communication with the referring physicians or patients, which in many circumstances is undesirable due to possibilities of inappropriate communication in cases where the recommended test was not scheduled nor performed, but a similar or a better test was performed instead, or a patient may have a contra-indication such as to an MRI, or a clinic note indicates an alternate plan. The present invention comprises a means by which such human oversight of this system may be performed, where needed, to enhance the quality of the desired functions.

### BRIEF SUMMARY

The invention addresses the problems described in the Abstract and Background of Invention sections, by detecting and identifying patients who did not obtain the relevant recommended diagnostic test or therapeutic intervention, typically by searching for textual patterns within electronic health records or radiology reports, and this method and system further refines, sorts and filters the detected recommendations to maximize the relevance of results, and optionally facilitates efficient management of the detected results, and comprises the means by which a human operator can efficiently supervise the system and manage tracking of the detected recommendations, facilitating secure communications with the affected clinicians and patients.

### BRIEF DESCRIPTION OF DRAWINGS

FIG. 1: Example module of a possible embodiment, which effects a display of sample results to the operator, who would typically be a hospital employee tasked with overseeing the system, and who would be able to decide which of the detected and filtered recommendations need further action, which recommendations do not need further tracking, and which should be re-checked for fulfillment at a later date. Depicted embodiment demonstrates an optional means of communication with patients, and optional means of accessing information contained in PACS or Chart.

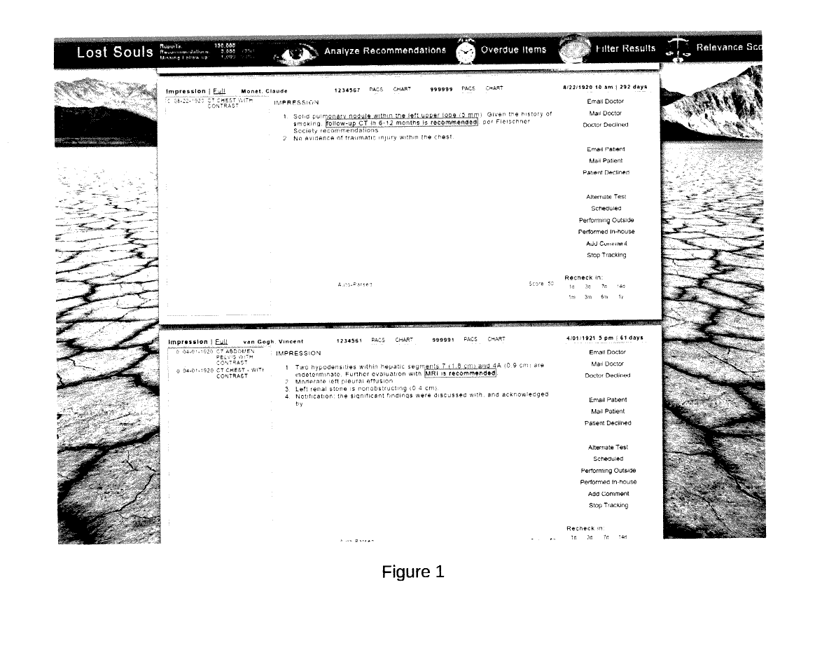

FIG. 2: Flowchart demonstrating example flow of information.

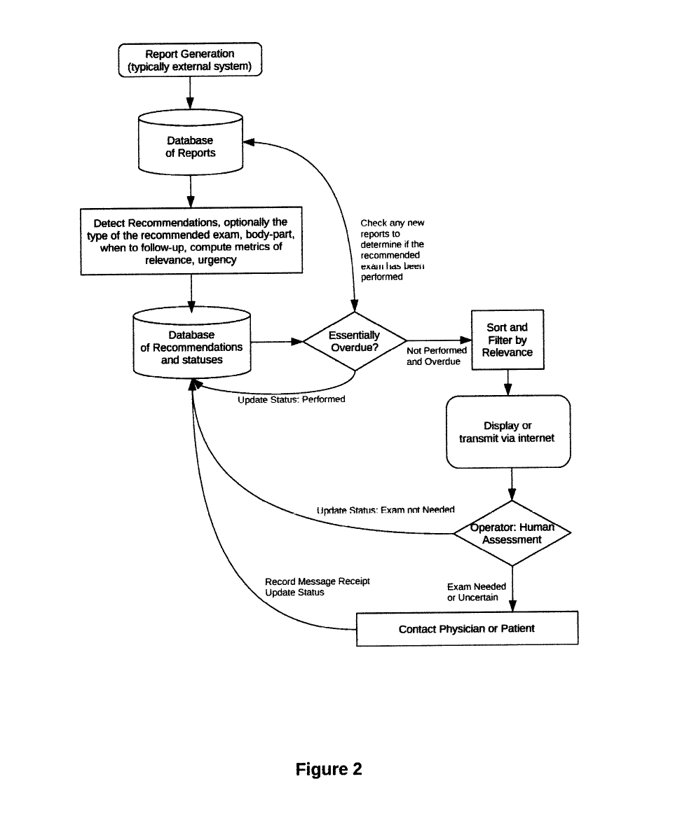

### DETAILED DESCRIPTION

Clarification of Terminology

In this patent application, inclusive of claims, exam refers to any healthcare-related diagnostic or therapeutic test or procedure or consultation, radiologic, surgical, medical, laboratory activity and similar, or a combination thereof.

In this patent application, inclusive of claims, report refers to any final, preliminary, or addended report, result or group of one or more statements arising from an exam, which includes text-based, styled-text, datum-based, structured, and media-containing reports, or a combination thereof (datum-based is explained below).

In this patent application, inclusive of claims, recommendation refers to any phrasing, act or information which could be interpreted by someone as implying a recommendation, suggestion, endorsement or implication that a particular exam or course of action is necessary, or desirable, or possibly helpful. This comprises at least one element from a set of elements comprising textual, verbal, template, structured, or datum-based recommendations. For clarity, a non-limiting example of datum-based report or recommendation may be found in existing report-generation systems which allow the physician to click a button such as a “follow-up with CT”, or “repeat mammogram in 1 year” and internally store this as a code or text, wherein this may be stored instead of text, alongside of text, or associated with a particular patient or report by use of an identifying information comprising examples in the broad categories of Medical Record Number, Accession Number, Patient Name, date of birth, a unique ID, computer data storage address, or vicinity of storage, which may be stored within a database or file separate from that which stores the reports.

In this patent application, inclusive of claims, “regular expressions” refer to widely-used computer programming and implementation techniques familiar to those skilled in the art. Multiple syntactical variants of regular expressions exist, and the invention is not limited to any particular variant or any particular computer language, or a compiled version thereof which may make use of deterministic finite automaton or Nondeterministic finite automaton.

A method and system is presented including a processor for analyzing reports (as defined above), detecting any previous recommendations (as defined above), and determining whether an exam (as defined above) has been performed subsequent to, or near-contemporaneously to, a report that made a recommendation for such an exam, presenting this information to a human operator or separate systems, and a means of facilitiating secure communication and tracking of the detected information. Although typical embodiments may analyze reports from a plurality of patients, an embodiment can also processes reports limited to a single patient.

Because at present the majority of reports produced in the healthcare industry are composed of electronic text, a lengthy discussion follows describing the methods by which a particular embodiment can process such reports to achieve the desired results. However, example embodiments of the invention which process only datum-based reports, or reports that are loosely associated with datum recommendations may optionally omit the implementation of some or all components that relate to natural language processing and may instead directly access any available datum pertinent to the recommendation, exam body-part, or time.

In cases where an embodiment is expected to process reports composed of electronic-text, this functionality and a means can be implemented by those skilled in the art, by use of a combination of one or more text-processing techniques from a set of Regular Expressions, Tokenization, ontology-based methods, and other Natural Language Processing, in order to identify phrases which imply that a recommendation was made. In example embodiments intended to process English language, such phrases include sequences of characters similar in meaning to “recommended”, “recommend”, “advised”, “suggested”, “consider”, “warranted”, “helpful”, “repeat”, “additional”, “evaluation”, “confirm”, “confirmation”, “attention” [on follow-up], and related synonyms.

An embodiment may be enhanced by a means of distinguishing the varying degrees of decisiveness, whereby phrases such as “is recommended” are considered more decisive or more relevant than “consider” or “CT may be obtained”. This could be implemented by a “relevance score”, “decisiveness score,” a category, or a functionally equivalent technique. In conjunction with this score, or as a substitution for such a score, a means may be implemented by which some indecisive recommendations are prevented from raising an alert or such recommendations are prevented from further tracking.

An embodiment may be enhanced by a means of determining whether the recommendation term is in close proximity or within the same sentence or clause, as other terms that describe which radiologic or medical procedure is being recommended. Although the implementor may be tempted to implement the technique of tokenizing the report into sentences at the sites of punctuation, exceptions to any such same-sentence rules may in some circumstances be desirable because occasionally physicians may omit periods or place punctuation in inappropriate places.

An example embodiment may extract from a unit of meaning, such as a sentence or a sequence of text, a combination of a recommendation phrase, and optionally test or procedure phrase, optionally a time phrase, and optionally a body-part phrase.

The means of time phrase processing may be enhanced by means of processing both a range and a specific date or time, and by a means of translating this to a specific time point or range of time points relative to the time of the exam. Examples of such time phrases which tend to occur in reports include “CT is recommended in 6-12 months”, “Annual follow-up”, “monthly”, “daily”, “in 10 days”, “on November 15”. Those skilled in the art of computer programming will be able to implement a means of translating these and similar phrases into a machine representation, and to combine this with the time of the scan to derive the appropriate meaning and compute an appropriate time. In cases where a range of time is specified, the desired time-point to check for completion may be configured to be within this range, or outside of it. It may be desirable for an end-user to check for completion of the recommended exam before or after this time. Therefore, an embodiment can adjust the extracted time by means of automated mathematical manipulation, in order to effect displaying of only overdue tests, or to proactively alert of tests which should be performed in the near future. Relevance score may be optionally adjusted based on time, such as to consider an exam to be of low relevance prior to the recommended time point, but of increasing relevance after the specified time point. Exams that are overdue by a very long time span such as 10 years may be optionally considered to be of decreasing relevance because most types of questioned pathologies would have became overt clinically if these were important. If a time-point is not specified, this may be assumed to represent a configurable duration, which may be same or different, depending on the type of the exam which made the recommendation, type of the recommended exam, location of the patient (such as Emergency Department), body-part, or presence of other information which would imply increased or reduced urgency.

An embodiment may be enhanced by a means of normalizing the extracted names of the exam and body-part. Examples of this normalization would translate “CTA Thorax” and “CT angiography of the chest” to the same internal representation, and also recognize “US Kidney” and “Renal Ultrasound” as essentially equivalent, and “biopsy” and “tissue sample” as equivalent. This normalization is more effective if all combinations of possible exams, body regions, and phrasing variants are accounted for, optionally also accounting for laterality. A possible embodiment may make use of Regular Expressions or another text-processing technique to implement this. If a body part is not explicitly stated in the recommendation, this can be inferred by automated means from the exam type which made the recommendation, or a reference to body region or pathology. Examples of such inference include “nephrolithiasis” implying abdomen or kidneys, “hepatic lesion” implying exams of the abdomen or liver, and an ultrasound of the pelvis recommending “a follow-up in 6 months” implying area of the pelvis.

An embodiment may be enhanced by a means of checking the available data intermittently, or in response to a triggering event, to determine if any of the following conditions have occurred: the recommended exam has been performed, scheduled, referenced in clinical notes, or referenced in another part of the medical record. Some of this data may not be available to a particular type or a particular instance of an embodiment, such as in cases where scheduling system is not accessible within a particular hospital. An important source of valuable data that is almost always available, is the set of the reports that are being checked for recommendations. Subsequent occurrence of the recommended exam within such set or other available data implies that the recommendation has been fulfilled, and the system need not to raise alerts or display the data associated with this patient, and the tracking of the recommendation may stop, optionally adjusting counters of statistical information.

It is possible that an exam scheduled for the future may never be actually performed, and thus it is recommended that the condition of “scheduled” be optionally used to postpone checking for completion rather than as an end-point to stop tracking the patient.

Variations of implementation may check that laterality, exam type, and body part match between the recommended exam and the subsequent exams. Furthermore, a means of automated scoring or similar metric may be useful to adjust the relevance score or similar of the recommendation. Examples of how an embodiment may adjust such a relevance score are: recommendation for a “CT head” may be considered less relevant in cases where “MRI head” was subsequently performed, or if “CT cervical spine” was recommended but a “CT neck” was subsequently performed. Those skilled in the arts of Radiology, Medicine, Surgery and Computer Science will be able to advise on, and implement the multitude of pertinent combinations arising from overlapping anatomical regions and modalities of exams, and implement pertinent scoring adjustment values, and advise where it is appropriate to treat the recommendation as “fulfilled” in cases where a similar or better test has been performed.

An embodiment may be enhanced by a means of decreasing the relevance score or optionally a means of stopping of tracking of some of the recommendations that are associated with conditional phrasing, such as “if pain persists... consider CT spine.”

An embodiment may be enhanced by a means of estimating the relative relevance, importance, and urgency of the recommendation, and scoring, sorting, and filtering of the detected results based on metrics of relevance, urgency, or similar, assigning varying scores based on the type of recommended action, and any presence of follow-up time-frame, category of the recommended modality (such as Radiology Test, Biopsy, Clinical Consultation), assessing the degree of decisiveness of recommendation (patterns such as “CT is recommended” may be considered more relevant than “consider CT” or “CT is suggested”, which can be implemented by a method similar to scoring or categorization.

An embodiment may be enhanced by a module component which provides a means by which a human operator of the system, can indicate a disposition of the detected recommendation by selecting a category from a broad set of categories comprising essentially equivalent categories to “Alternate Test”, “Scheduled”, “Performed at another institution”, “Add Comment”, and “Stop Tracking”. Such a means of selecting categories may optionally include a display device, input devices such as, for example, a keyboard, a mouse, touch display, or a means of transmitting information between one or more systems, such as in embodiments that utilize a server computer which communicates with a separate web-browser or client application.

In some circumstances, it may be desirable to use a dedicated operator of the system who can ensure quality and relevance of communication prior to contacting the physicians or patients, and who can find additional pertinent information such as telephone numbers. In other circumstances it may be desirable to have the embodiment contact the affected physicians and patients in an automated fashion, without the involvement of an operator.

An embodiment may be enhanced by a means of displaying the detected recommendations, associated with configurable amount of contextual text. This may be further enhanced by a means of highlighting the phrases or sentences containing the recommendation, optionally using different colors to highlight the modality, time-frame, and body-region.

An embodiment may be enhanced by a means of allowing a human operator of the system to indicate and instruct the system to postpone further action until a specific date or for a specific duration. At such a later time, an embodiment can optionally re-check if the recommended exam has been performed, scheduled, or if there is new data available within the health records that would imply a disposition. Example of such data may be a note stating “CT recommended an MRI. Patient has a contraindication to MRI. Will follow-up with blood test instead.”

An embodiment may be enhanced by combination with a means that facilitates secure communication of the detected information with the affected clinician or patient, and further enhanced by a means of reverse communication, whereby the clinician or patient is able to communicate back their responses. The embodiment may be enhanced by a means of recording acknowledgement of message receipt, optionally a response type (such as “test will be performed”, “exam has been obtained at another institution”, “alternate test was performed”, “patient declined the test”). Such means of communication may further be enhanced by use of encryption and optionally a means of an out-of-band transmission of password or key.

An embodiment may be enhanced by a means of generating communications based on templates, such as letters intended to be sent via postal mail or a secure electronic transmission, wherein some text is provided

An embodiment may be enhanced by a means of displaying a list of other exams performed on a particular patient, which would allow a human operator to quickly assess if an exam similar to the recommended exam has been performed.

An embodiment may be enhanced by a means of invoking another system and directing this other system to display or process information pertaining to a particular detected patient. An example of this may be a button, link, or key that when activated, causes the patient's information to be displayed within a same-vendor or third-vendor Electronic Health Record, PACS (Picture archiving and communication system), or a scheduling system.

With clarifications of report, exam, recommendation, and regular expression as per clarifications above, I claim:

1. A method and system of analyzing health-care reports for determining which patients did not obtain an exam that was recommended by a prior report, comprising a processor and a non-transitory computer-readable storage medium, and a means of detection that a prior report made a recommendation.

2. Claim 1, wherein the said means of recommendation detection comprises a means from a set of means that comprises regular expression, tokenization, ontology-based method, natural language processing, extraction from at least one datum.

3. Claim 2, wherein the said means of recommendation detection comprises a means of extracting information associated with the recommendation, comprising an element from a set of elements comprising the recommended exam type, suggested time point of the recommended exam, body part.

4. Claim 2, wherein the said means of recommendation detection comprises a means of assessing the degree of decisiveness of the recommendation.

5. Claim 2, wherein the said means of recommendation detection comprises a means of determining if the recommendation is conditional.

6. Claim 2, wherein a metric of a detected recommendation is estimated by a means of scoring, categorization, or a combination of scoring and categorization based on information associated with the detected recommendation, to compute at least one metric from a set of metrics comprising relevance, urgency, importance, time, conditional status of the recommendation.

7. Claim 2, comprising means of comparing the extracted recommended exam to any of the subsequent reports pertaining to the same patient, to determine if an exam matching or essentially equivalent to the recommended exam has been performed.

8. Claim 7, wherein the said means of comparing comprises least one set of comparisons comprising: comparison of recommended exam type vs. subsequent exam type, comparison of recommended body part vs. subsequent exam body part, comparison of recommended laterality vs. subsequent exam laterality.

9. Claim 7, wherein the said report comprises radiology reports.

10. Claim 7, wherein the said any of the subsequent reports are obtained from the same data set as the report which made the recommendation.

11. Claim 6, further comprising a means of adjusting any of the said metrics based on current time relative to the time which was suggested by the recommended exam, or assumed from the recommended exam.

12. Claim 6, further comprising a means of presenting any information that is associated with the detected recommendation to a human.

13. Claim 12, wherein the means of presenting comprises at least one means from a set of means comprising a display device, transmission of the said information to another device.

14. Claim 12, further comprising a means by which the said human can indicate the status associated with of the presented information.

15. Claim 14, wherein the status comprises a status similar to at least one status from a set of statuses comprising: exam has been performed, alternate plan has been chosen, stop further tracking, delete.

16. Claim 12, further comprising a means by which the said human can direct the system to postpone presenting the said presented information.

17. Claim 12, further comprising a means by which the said human can initiate contact with a patient or physician or both patient and physician, wherein the said means of contact comprise at least one means from a set of means comprising email, message printed on paper, secure communication, fax.

18. Claim 7, further comprising a means of re-checking subsequent reports for the purpose of determining if the recommended exam has been performed since a prior check.

19. Claim 12, further comprising a means of filtering and preventing the presentation of a subset of the detected recommendations to a human, based on an element from a set of elements comprising: a combination of current time relative to the time that was implied by the exam that made the recommendation, a metric score, recommended exam type.

20. Claim 7, wherein the said method and system further comprise a means of storing information associated with a detected recommendation on a computer-readable medium.

21. Claim 12, further comprising a means of demarcating text by a means from a set of means comprising highlighting the background color, applying a color to letters, underlining, displaying a border, causing the font to appear larger, causing the font to appear bold.

22. Claim 21, further comprising a means of applying different demarcation to words based on type of word, from a set of types comprising exam type, body part, time, recommendation.

23. Claim 12, further comprising means of sorting the detected recommendations based on at least one metric.

24. Claim 3, further comprising a means of normalizing the extracted information, wherein any phrase from a set of synonymous phrases is recognized as equivalent to the other phrases within this set.

25. Claim 24, wherein the said means of normalizing comprises a method from a set of methods comprising regular expressions, lookup-table.

26. Claim 1, further comprising statistical information that includes an element from a set of elements comprising number of reports, number of reports that make a recommendation, number of reports that make a recommendation and for which the recommended exam was not yet performed.

27. Claim 17, further comprising a means by which the said patient or physician can respond, and the said response is recorded on a non-transitory computer medium.

28. Claim 17, wherein the said means of contact comprises transmission of passcode required for decryption, wherein this passcode comprises an element from a set of elements comprising password, access code, decryption key.

29. Claim 28, wherein a passcode is encoded as an element from a set of elements comprising a QR code, barcode, text, Uniform Resource Locator (URL).

30. Claim 12, wherein the said presentation provides a means of accessing additional information pertaining to the patient comprising an element from a set of elements comprising a button, link, key.
